(19) United States
(12) Patent Application Publication
(10) Pub. No.: US 2007/0023229 A1
(43) Pub. Date: Feb. 1, 2007

(54) DIAPHRAGM FOR MICRO-ELECTROACOUSTIC DEVICE

(75) Inventor: TSUNG-LUNG YANG, TUCHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO.,LTD., Tu-Cheng (TW)

(21) Appl. No.: 11/308,412

(22) Filed: Mar. 22, 2006

(30) Foreign Application Priority Data
Jul. 29, 2005 (CN) 200510036281.7

(51) Int. Cl. G10K 13/00; H04R 7/00

(52) U.S. Cl. 181/174; 181/173

(57) ABSTRACT

A diaphragm for a micro-electroacoustic transducer, includes a first layer including an exposed region and a covered region, and a second layer. The second layer overlaps the covered region of the first layer to thereby increase the rigidity of the diaphragm. The covered region is surrounded by the exposed region.

### FIELD OF THE INVENTION

The present invention relates generally to a micro-electroacoustic device, and more particularly to a diaphragm of a micro-electroacoustic device.

### DESCRIPTION OF RELATED ART

Sound is one important means by which people communicate with each other, thus creating new methods for sound transference allows greater communication between people. Electroacoustic transducers are key components in transferring sound. A typical electroacoustic transducer has a magnetic circuit in which a magnetic field generated by a magnet passes through a base member, a magnetic core and a diaphragm and returns to the magnet again. When an oscillating electric current is supplied to a coil wound around the magnetic core, the corresponding oscillating magnetic field generated by the coil is then superimposed onto the magnetostatic field of the magnetic circuit. The resulting oscillation generated in the diaphragm is then transmitted to the air as sound. The basic loudspeaker, in which electric energy is converted to acoustic energy, is a typical electroacoustic transducer. There are many different types of loudspeakers, including electrostatic loudspeakers, piezoelectric loudspeakers, and moving-coil loudspeakers.

Nowadays, mobile phones are widely used and loudspeakers are important components packaged within mobile phones. As design style for mobile phones emphasizes lightness, thinness, shortness, smallness, energy-efficiency, low cost, the space available for loudspeakers within mobile phones is therefore limited. Furthermore, as more and more mobile phones are being used to play MP3s, the rated power of the loudspeakers needs to increase. The space occupied by loudspeakers mainly depends on maximum deformation displacement of a diaphragm of the loudspeaker.

Therefore, it is desired to design a new diaphragm for micro-electroacoustic transducers which can have a reduced deformation displacement when a rated power (force) exerted to the diaphragm is unchanged or even increased.

### SUMMARY OF INVENTION

A diaphragm for a micro-electroacoustic transducer in accordance with a preferred embodiment of the present invention comprises a first layer including an exposed region and a covered region. A second layer overlaps the covered region of the first layer to thereby increase the rigidity of the diaphragm. The maximum deformation displacement of the diaphragm is accordingly reduced compared with conventional diaphragms when undergoing a same power (force). Thus, loudspeakers fitted with the diaphragms of the present invention occupy a smaller space than loudspeakers with conventional diaphragms while can have the same power output. Understandably and alternatively, loudspeakers fitted with the diaphragms of the present invention and occupying the same amount of space as loudspeakers fitted with conventional diaphragms can undergo larger amounts of power input (force) and can have larger power output. This is due to the rigidity of the diaphragm in the present invention being larger than that of the conventional diaphragm.

Other advantages and novel features of the present invention will become more apparent from the following detailed description when taken in conjunction with the accompanying drawings, in which:

### BRIEF DESCRIPTION OF DRAWINGS

FIG. 1 is a cross-sectional view of a diaphragm in accordance with a first embodiment of the present invention;

FIG. 2 shows deformation displacement of two types of diaphragms under force P;

FIG. 3 is a cross-sectional view of a diaphragm in accordance with a second embodiment of the present invention; and

FIG. 4 is a cross-sectional view of a diaphragm in accordance with a third embodiment of the present invention.

### DETAILED DESCRIPTION

Reference will now be made to the drawing figures to describe the preferred embodiment in detail.

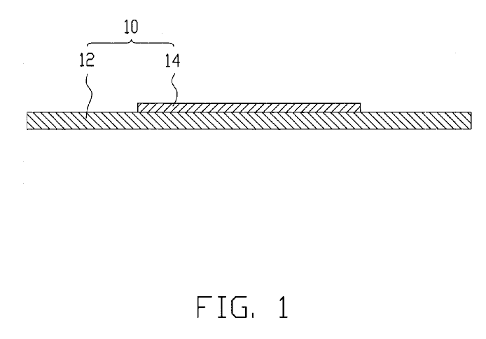

FIG. 1 is a cross-sectional view of a diaphragm 10 in accordance with a first embodiment of the present invention. The diaphragm 10 is used for micro-electroacoustic transducers, such as the loudspeakers of mobile phones or notebooks. In the preferred embodiment, the diaphragm 10 is tubular-shaped and round as viewed from above. The diaphragm 10 comprises a first layer 12 and a second layer 14. The first layer 12 comprises a covered region located at a central portion thereof and an exposed region surrounding the covered region. The diameter of the second layer 14 is smaller than that of the first layer 12. The second layer 14 overlaps on the covered region of the first layer 12 and is substantially concentric with the first layer 12. Thus, the thickness of the central portion of the diaphragm 10 is larger than that of the peripheral portion of the diaphragm 10. The first and second layers 12, 14 are made of a polymeric material, such as PEI, PI, PP, PEN or PET.

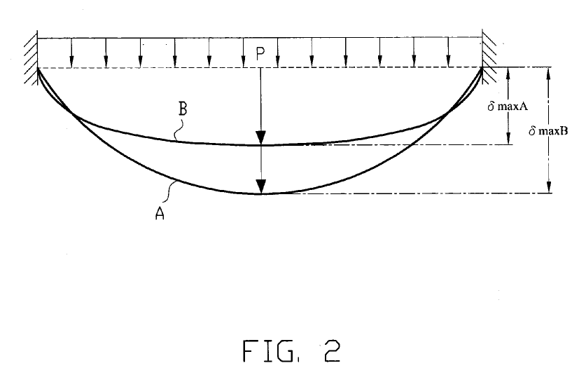

Generally, the thickness of a diaphragm of a micro-electroacoustic is measured in microns while the diameter of the diaphragm is measured in millimeters. FIG. 2 shows a relationship between deformation displacement of two diaphragms and force P exerted on the diaphragms. Curved line A represents a conventional diaphragm which only includes the first layer 12. δ_{maxA} represents the maximum deformation displacement of the conventional diaphragm. Curved line B represents the diaphragm 10 of the preferred embodiment of the present invention, which includes both the first layer 12 and the second layer 14. δ_{maxB} represents the maximum deformation displacement of the diaphragm 10 of the preferred embodiment. Curved line A shows that the maximum deformation displacement of the conventional diaphragm occures at the center of the diaphragm and is much larger than that occurring at the peripheral portion of the diaphragm. Curved line B shows the maximum deformation displacement of the diaphragm 10 of the preferred embodiment is less than that of the conventional diaphragm and the deformation displacement of the central portion of the diaphragm 10 is a little larger than that of the peripheral portion of the diaphragm 10. That is, compared with the conventional diaphragm, the maximum deformation displacement of the diaphragm 10 of the preferred embodiment of the present invention is less when undergoing the same force. This is because in the diaphragm 10 of the preferred embodiment the second layer 14 overlaps on the central portion of the first layer 12, thereby increasing the rigidity of the diaphragm 10.

In order to test the effect of the second layer 14 on the diaphragm 10, the applicant has used a variety of kinds of second layers 14 with different thicknesses to overlap the same first layer 12. The thickness of the first layer 12 is 30 um and the diameter thereof is 20 mm. The diameters of the second layers 14 are all 10 mm. The thicknesses of the second layers 14 are 0.1˜2.0 times of that of the first layer 12. Other conditions for conducting the tests are the same. Table 1 shows the results of the tests.

TABLE 1

| | The maximum deformation |
|---|---|
| The thickness of the | displacement of the |
| second layer | diaphragm |
| (um) | (deformation units) |
| 3 | 1736 |
| 6 | 231.931 |
| 9 | 80.371 |
| 12 | 43.014 |
| 15 | 29.018 |
| 18 | 22.089 |
| 21 | 17.85 |
| 24 | 14.854 |
| 27 | 12.558 |
| 30 | 10.73 |
| 33 | 9.254 |
| 36 | 8.056 |
| 39 | 7.084 |
| 42 | 6.294 |
| 45 | 5.649 |
| 48 | 5.123 |
| 51 | 4.69 |
| 54 | 4.33 |
| 57 | 4.037 |
| 60 | 3.79 |

From table 1, one can conclude that the thicker the second layer 14 is the smaller the maximum deformation of the diaphragm 10 is. That is, the rigidity of the diaphragm 10 is increased when the thickness of the second layer 14 increases. Similarly, when the thickness of the first layer increases the rigidity of the diaphragm 10 is also increased.

In order to test the effect of the second layer 14 on the diaphragm 10, the applicant has used a variety of kinds of second layers 14 with different densities. The second layers 14 overlap the same first layer 12. The thickness of the first layer 12 is 30 um and the diameter of the first layer 12 is 20 mm. The first layer 12 is made of polymer material. The diameters of the second layers 14 are all 10 mm and the thicknesses of the second layers 14 are all 30 um. The density of the second layer 14 is 0.1˜2.0 times of that of the first layer 12. Other conditions for conducting the tests are the same. Table 2 shows the results of the tests.

TABLE 2

| | The maximum |
|---|---|
| | deformation displacement |
| density ratio of the second | of the diaphragm |
| layer to the first layer | (deformation units) |
| 0.1 | 1736 |
| 0.2 | 231.931 |
| 0.3 | 80.371 |
| 0.4 | 43.014 |
| 0.5 | 29.018 |
| 0.6 | 22.089 |
| 0.7 | 17.85 |
| 0.8 | 14.854 |
| 0.9 | 12.558 |
| 1.0 | 10.73 |
| 1.1 | 9.254 |
| 1.2 | 8.056 |
| 1.3 | 7.084 |
| 1.4 | 6.294 |
| 1.5 | 5.649 |
| 1.6 | 5.123 |
| 1.7 | 4.69 |
| 1.8 | 4.33 |
| 1.9 | 4.037 |
| 2.0 | 3.79 |

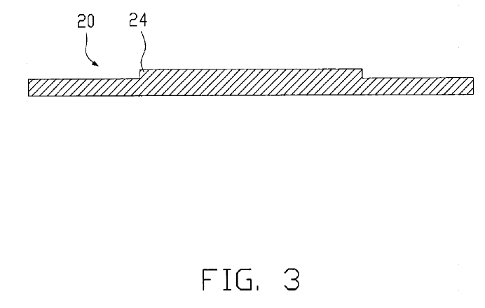

Table 2 shows that as the density ratio of the second layer 14 to the first layer 12 is increased the rigidity of the diaphragm 10 increases also, which results in the maximum deformation displacement of the diaphragm 10 being reduced when the density of the second layer 14 is increased. [0016] FIG. 3 shows a cross-sectional view of a diaphragm 20 in accordance with a second embodiment of the present invention. The diaphragm 20 is integrally formed and has a circular bump 24 formed at a central portion thereof. The thickness of the central portion of the diaphragm 20 is therefore larger than that of the peripheral portion of the diaphragm 20, which results in the rigidity of the diaphragm 20 being increased. The periphery of the bump 24 is preferable concentric with the periphery of the diaphragm 20.

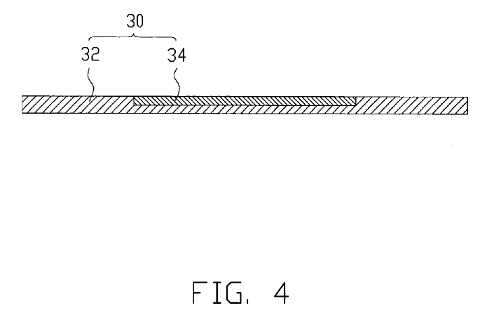

FIG. 4 shows a cross-sectional view of a diaphragm 30 in accordance with a third embodiment of the present invention. The diaphragm 30 comprises a first layer 32 and a second layer 34. The first layer 32 defines a recess in a central portion of a top surface thereof. The second layer 34 is received in the recess of the first layer 32. The depth of the recess of the first layer 32 is the same as the thickness of the second layer 34 so that the top surface of the first layer 32 is coplanar with the top surface of the second layer 34. The second layer 34 is made of a material which has a larger density than that of the first layer 32. Thus, the rigidity of the central portion of the diaphragm 30 is increased which results in the rigidity of the diaphragm 30 being increased. Alternatively, the depth of the recess of the first layer 32 may be smaller than the thickness of the second layer 34 to allow the second layer 34 to protrude from the first layer 32.

In the present invention, the diaphragms 10, 20, 30 comprise a central portion and a peripheral portion. The ridigity of the central portion is made larger than that of the peripheral portion either by increasing the thickness of the central portion or by increasing the density of the material of the central portion, which results in the rigidity of the diaphragm 10, 20, 30 being increased and the maximum deformation displacement of the diaphragm 10, 20, 30 being accordingly reduced when undergoing the same power input (force). Thus, the loudspeakers fitted with the diaphragms 10, 20, 30 of the present invention occupy smaller space than loudspeakers using conventional diaphragms. Understandably, loudspeakers fitted with the diaphragms 10, 20, 30 of the present invention and occupying the same space as the loudspeakers fitted with conventional diaphragms can undergo larger amounts of power input (force) and accordingly can generate larger power output. This is due to the rigidity of the diaphragm of the present invention being larger than that of a conventional diaphragm.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A diaphragm for a micro-electroacoustic transducer, comprising a first portion and a second portion, wherein the rigidity of the first portion is larger than that of the second portion, the second portion surrounding the first portion.

2. The diaphragm as described in claim 1, wherein the diaphragm comprises a first layer comprising an exposed region and a covered region, and a second layer overlaps the covered region of the first layer, the second layer and the covered region of the first layer forming said first portion, the exposed region of the first layer forming said second portion.

3. The diaphragm as described in claim 2, wherein the first layer and the second layer both are circular and concentric with each other.

4. The diaphragm as described in claim 3, wherein the thickness of the first portion is larger than that of the second portion.

5. The diaphragm as described in claim 3, wherein the thickness of the first portion is the same as that of the second portion.

6. The diaphragm as described in claim 2, wherein the density of the second layer is larger than that of the first layer.

7. The diaphragm as described in claim 6, wherein the first layer defines a recess in which the second layer is received.

8. The diaphragm as described in claim 1, wherein the diaphragm is made of one of PEI, Pi, PP, PEN and PET.

9. The diaphragm as described in claim 1, wherein the diaphragm is integrally formed and the first portion is thicker than the second portion.

10. A diaphragm for a micro-electroacoustic transducer, comprising a first layer comprising an exposed region and a covered region, and a second layer overlaps the covered region of the first layer to increase a rigidity of the diaphragm.

11. The diaphragm as described in claim 10, wherein the first layer and the second layer both are circular and concentric with each other and the exposed region surrounds the covered region.

12. The diaphragm as described in claim 10, wherein the density of the second layer is larger than that of the first layer.

13. The diaphragm as described in claim 10, wherein the first layer defines a recess in the covered region thereof, and the second layer is received in the recess.

14. The diaphragm as described in claim 10, wherein the first layer and the second layer are integrally formed.

15. The diaphragm as described in claim 10, wherein the first layer and the second layer are respectively made of one of PEI, Pi, PP, PEN and PET.

16. The diaphragm as described in claim 10, wherein the diaphragm is tubular-shaped.

17. A diaphragm for use in a micro-electroacoustic transducer comprising:
a first layer and a second layer located at a central portion of the first layer, the second layer reinforcing the central portion of the first layer to increase a rigidity of the diaphragm.

18. The diaphragm as described in claim 17, wherein the second layer overlaps the first layer so that the diaphragm has a larger thickness at the central portion thereof, the first and second layers being made of the same material.

19. The diaphragm as described in claim 18, wherein the first and second layers are integrally formed as one piece.

20. The diaphragm as described in claim 17, wherein the second layer is embedded in a recess defined in the first layer, and the second layer is made of a material having a density larger than that of a material for forming the first layer.
